(19) United States
(12) Patent Application Publication
(10) Pub. No.: US 2014/0342170 A1
(43) Pub. Date: Nov. 20, 2014

(54) COMPOSITION FOR SURFACE DECORATION AND THE PRODUCTION OF VARIOUS OBJECTS, AND PREPARATION METHOD THEREOF

(71) Applicant: Jean-Luc GUICHARD, Marseille (FR)

(72) Inventor: Jean-Luc GUICHARD, Marseille (FR)

(73) Assignee: PEBEO (Societe Anonyme a directoire et conseil de surveillance), Gemenos (FR)

(21) Appl. No.: 13/894,749

(22) Filed: May 15, 2013

(51) Int. Cl. C09D 5/29

(52) U.S. Cl. CPC C09D 5/29
USPC 428/480; 524/599; 524/449; 524/394

(57) ABSTRACT

A composition for the decoration of surfaces and for producing decorative objects includes a colloidal mix containing an organic binder with physical drying (evaporation of solvents), pearly pigments, coloring pigments, and mainly aliphatic organic solvents. The decorative composition is in the form of a homogenized liquid product that can be poured on a horizontal surface so as to form a uniform colored coat that has a random mosaic appearance after a drying time.

### CROSS-REFERENCE TO RELATED U.S. APPLICATIONS

Not applicable

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention relates to the field of decorative paints. It is particularly applicable to a composition for the decoration of a variety of different types of surfaces and the various articles that may be decorated or produced using this composition. It also relates to the method for preparing this decorative composition.

2. Description of Related Art Including Information Disclosed Under 37 CFR1.97 and 37 CFR 1.98.

“Decorative paints” normally refer to surface coating products with special effects obtained by:
“spattering” (droplets of one color of paint sprayed on top of a first coat of another color);
spraying of particles: very fine colored grains, spangles, etc.;
“mixing” of superposed colors (so-called “sponge” paints, “cloudy” or “pearly” finishes, etc.).

Applications of these methods, are usually limited to coverage of large areas such as walls or other solid surfaces of buildings. They require the use of several specific products, manipulations of these products, instruments or equipment appropriate for the operations to be performed, and successive steps to apply the products on the receiving surfaces.

Secondly in the world of decorative arts, for example for the fabrication of painted enamels, artists also use special products applied on a support in successive steps, including spreading of a first coat of colorless or colored varnish (enamel) onto the support and then after baking this first coat at an appropriate temperature, the pattern is applied onto it by applying and then baking each color in the pattern in turn, the different colors in the pattern being baked separately because they are usually composed of vitrifiable very finely ground enamels, frequently bonded by an oil that does not fuse at the same temperature. These different enamels are traditionally applied with a brush, but spraying devices suitable for this work also exist.

This is tedious work, in which many problems can arise and which requires good dexterity and experience.

Furthermore, products and methods currently available for the general public for decoration and personalization of ail types of supports such as wood, metal, glass, porcelain, ceramic and textiles, are not conducive to the development of decoration and customization activities for the general public, although these activities have expanded considerably during the last two decades.

Document WO-2010/004227 discloses, a method for obtaining powder paints containing different types of pigments with different effects (interferential, diffracting, reflecting). The product described in this document is in powder or granular form and cannot be used to cover an article to be decorated by pouring the product on a horizontal surface so as to form a uniform colored coat which will have a random mosaic appearance after drying.

Document DE-10.2008.009481 discloses a method for obtaining a coating for different substrates, particularly metal substrates and particularly substrates encountered in the automobile industry, designed to perform the same role as conventional “base coat/clear coat” type coatings, but that minimize “pin holes” type, defects often, present, during application of these conventional coatings,

The method described in this document uses enamels sprayed in thin coats onto automobile bodywork. There is no effect, no grading, and no particular required color. Furthermore, according to this document, the only required effect is to obtain a uniform result with no defects while drying.

Document WO-2006/056644 discloses the distribution of paint in its aqueous phase at sales outlets. The different possible effects of these paints include effects obtained using pearly or iridescent or metallic pigments are mentioned, but no mention is made of the cell type effects producing a random mosaic appearance.

Document DE-198.13.394 discloses a preparation of various types of pigments, particularly pigments with special effects, pearly, holographic effects, etc., so as to bond them to an organic matrix. The product is in the form of dry pellets, easily dispersible into appropriate solvent media and pre venting the generation of dust during application in fabrication workshops, that would require the use of very efficient worker protective equipment.

Therefore the product described in this document is in a powdery, granular form that cannot cover an article to be decorated by pouring the product on a horizontal surface so as to form a coat with a uniform color and which will have a random mosaic appearance after a drying time.

Document EP-2.058.374 describes how to obtain iridescent pigments with very good outdoor resistance qualities, and the composition of paints or coatings, printing inks or adhesives containing these iridescent pigments. The effect obtained using these iridescent pigments does not describe the formation of cells providing a random mosaic appearance.

The invention proposes to provide artists and more generally amateur or professional creative designers with a decorative ready-to-use composition, in other words that does not require any manipulation prior to use and which can be used to obtain surfaces and objects with a new and attractive ornamental appearance without the use of any special instruments or equipment, and without the need for any prior learning or initiation.

### BRIEF SUMMARY OF THE INVENTION

According to the invention, this objective is achieved by means of a colloidal composition composed of a mix containing an organic binder with physical drying (evaporation of solvents), pearly pigments, coloring pigments, mainly aliphatic organic solvents, and remarkable in that it is in the form of a homogenized liquid product that can be poured on a horizontal surface so as to form a uniform colored coat that has a random mosaic appearance after a drying time.

According to another important characteristic feature, the organic physical drying binder is an oxidative drying binder.

According to another advantageous characteristic feature, the pearly pigments are mica-titanium dioxide type pigments.

According to another useful characteristic feature, the colloidal mix according to the invention contains a thickening mineral filler.

Preferably, this colloidal mix also contains drying metal soaps.

It may also advantageously contain an organic thickener.

Preferably, the decorative paint according to the invention also contains an anti-skinning agent.

This anti-skinning agent inhibits the action of drying agents in the liquid product obtained. It prevents the formation of skins during storage of the product in its closed flask. The inhibiting action disappears when the product is applied on its support and the anti-skinning agent can evaporate. The action of drying agents can then take place and oxidative drying occurs.

For example, the anti-skinning agent may be composed of 2-butanone oxime or cyclohexanone oxime.

According to one characteristic feature, the composition according to the invention has a viscosity of the order of 1000 mPa·s.

According to another characteristic feature, the visible decorative face(s) of the objects to which the decorative paint is applied is (are) covered with a transparent protective coat, for example composed of a glazing resin.

According to the method disclosed by the invention, the organic hinder with physical and oxidative drying and the mainly aliphatic organic solvents are added into a vessel, these ingredients being stirred by a mixer that may advantageously be a turbine mixer, installed in said vessel.

The thickening mineral filler and the pearly pigments of mica-titanium dioxide are then added, while stirring. Stirring is continued until a homogeneous mix is obtained.

An additional quantity of organic binder with physical and oxidative drying, coloring pigments, one or several of the following other ingredients—drying metal soaps, anti-skinning agent, organic thickener, and a complementary quantity of mainly aliphatic organic solvents—are added while stirring.

Stirring is continued until a homogeneous mix is obtained.

The turbine rotation speed is adjusted during stirring if necessary, to maintain a good vortex.

Samples may be taken at the end of the process to check the quality of the composition of the product obtained.

The decorative composition obtained using the method according to the invention is in the form of a homogenized liquid product that may be poured onto a horizontal surface so as to form a uniform colored layer which has a random mosaic appearance after a drying time, this appearance resulting from the appearance of small nearby ornamental patterns in the form of “cells” in the body of the sprayed layer, and that will be referred to as “cells” in the remainder of this description and in the claims.

As will be better understood after reading the following presentation, the decorative composition according to the invention, can easily be used to obtain ornamental patterns and qualitative results from a ready-to-use product offering professional and amateur artists the possibility of producing new product ranges remarkable due to their original ornamental effect, for example such as jewelry, bracelets, miscellaneous boxes, jewelry boxes, earrings, table sets, coasters. It also encourages inexperienced users to get started in creative or decorative leisure activities.

This composition has other advantages:
its viscosity is such that the product will spontaneously spread when it is poured on a horizontal surface;
it forms patterns (cells), during the drying steps obtained by spontaneous juxtaposition of accumulations of dispersed phase and continuous phase on the surface of the paint coat;
patterns (cells) with a large color contrast between the inside and the outside of the cell are produced spontaneously during drying of the decorative paint coat;
it is dry to touch, within a time after between 1 h and 3 h and is fully dry after between 24 h and 48 h depending on the thickness of the deposited coat, the coat obtained keeping a satin-gloss finish;
after drying, it has a chemical resistance to alcoholic, slightly basic or slightly acid aqueous solutions, or solutions containing surfactants;
it is composed of a continuous phase (binder in solution in solvents) and a dispersed phase (solid particles); the continuous phase possibly being light in color and the dispersed phase being dark, or vice-versa.
it facilitates re-suspension of the dispersed phase in the continuous phase after a more or less long period of storage or when not being used, that caused a limited sedimentation of the dispersed phase within the continuous phase;
due to its composition, it complies with European standards applicable to this type of “decorative leisure” product aimed at the adult general public.

BRIEF DESCRIPTION OF THE SEVERAL VIEWS OF THE DRAWINGS

The purposes, characteristics and advantages mentioned above and others will become clearer after reading the following description and the appended drawings in which:

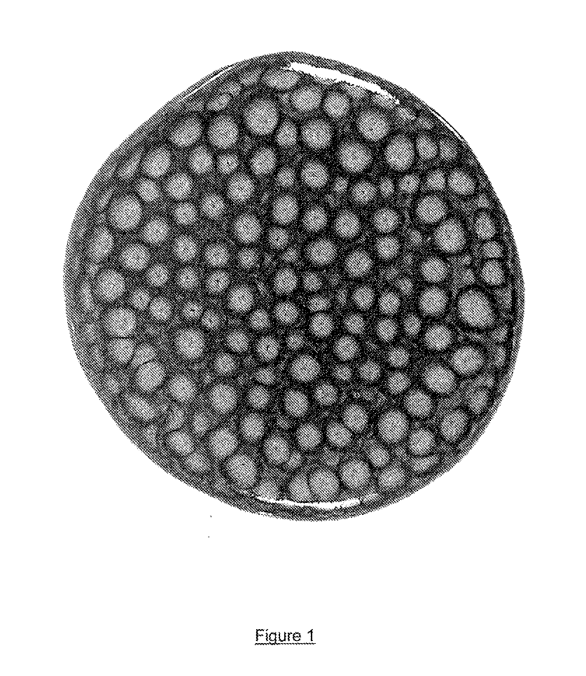

FIG. 1 shows an example of decorative patterns using the invention;

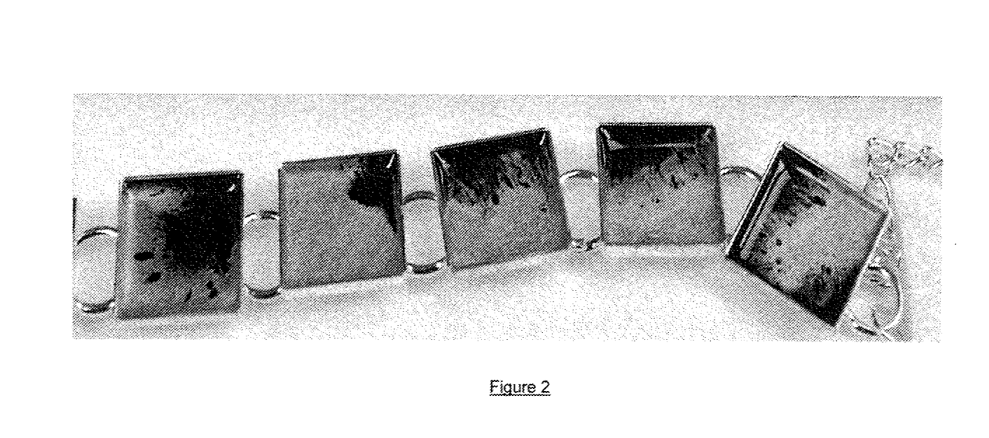

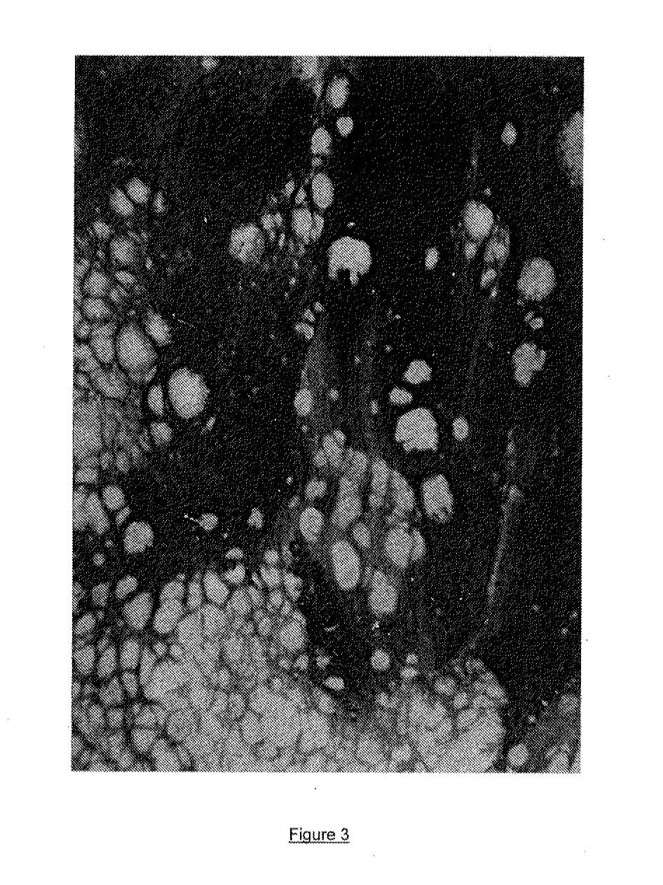

FIGS. 2 and 3 respectively show two objects decorated using this composition; and

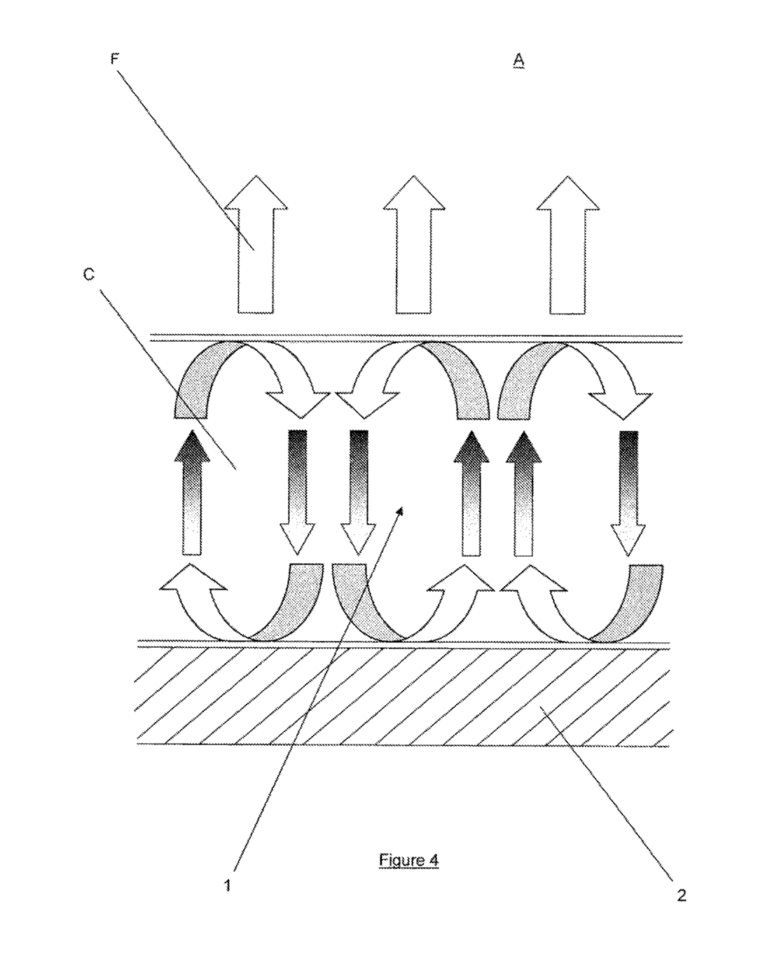

FIG. 4 is diagrammatic view showing the functional principle by which cellular patterns are obtained during drying of the decorative composition layer, based, an the phenomenon known as “Bénard cells”.

### DETAILED DESCRIPTION OF THE INVENTION

Said drawings will be referred to describe interesting examples, although they are in no way limitative, of production of the colloidal composition and use of the method according to the invention.

In the following description, the term “cells” is used to describe patterns with similar appearances that appear quickly and spontaneously in the coat spread on a support in the viscous liquid state.

The expression “coloring pigments” will be used in the description and in the following claims, to refer to pigments with a coloring action.

The composition or the colloidal decorative paint according to this invention is remarkable mainly in that it comprises a continuous phase composed of an organic binder with physical drying, in solution in mainly aliphatic organic solvents, and a dispersed phase (solid particles) composed of pearly pigments and soluble coloring pigments.

According to another important characteristic feature, the organic binder with physical drying is composed of an oxidative drying binder.

Physical drying enables evaporation of the solvents, while oxidative drying changes the nature of the organic polymer forming the organic binder due to the oxygen present in the air, to transform it into a thermosetting product with better resistance to organic solvents such as alcohol, ammonia, surfactants, etc.

The organic binder with physical and oxidative drying may be composed of an alkyd resin, an alkyd-polyester or other.

Pearly pigments also called nacres or interfering pigments are advantageously formed from pigments of the type based on mica in the form of a stack of coats or metallic oxide sheets: they may be composed of an iron II or III oxide, an antimony oxide or a titanium dioxide. These are pigments that have been treated; their multi-layer appearance gives a pearly effect and an interfering effect due to diffraction of light by the different coats.

The difference between the coloring pigments dispersed in the continuous phase lies in the fact that the coloring agents are soluble in the medium, but this is not the case for the pearly pigment. There is no interfering effect like there is for pearly pigments.

The type of the coloring pigment used and its percent per mass in the decorative composition naturally depends on the color of the final product to be obtained.

Interestingly, the decorative paint contains a thickening mineral filler, for example composed essentially of fine silica particles, fine chalk particles, or fine marble particles or talc. In the application to the invention, this mineral filler thickens the medium to make it easier to re-homogenize the product. It increases the distance between particles during sedimentation of the pearly pigments during product storage periods while waiting for use, to prevent the formation of lumps in said product.

According to another advantageous feature, the decorative paint contains drying metal soaps satisfying the function of oxidation catalysts (oxidation accelerators) that enable the binder to dry (oxidize) within reasonable times.

Preferably, the decorative paint also comprises an organic thickener, for example composed of starch, flour, gum, etc., to adjust the optimum viscosity of the product to achieve a controllable flow of the product during its use.

Also preferably, this decorative paint also comprises an anti-skinning agent, for example composed of 2-butanone oxime or cyclohexanone oxime.

The following table gives examples of percent by mass of raw materials used in the composition of the decorative paint, for guidance only.

| Nature of the raw material used | approximate % by mass |
|---|---|
| Organic binder with physical drying | 30% to 45% |
| (evaporation of solvents) and oxidative drying | |
| Pearly mica-titanium dioxide pigments | 5% to 20% |
| Coloring pigments | <10% |
| Thickening mineral filler | <5% |
| Drying metal soaps | <1% |
| Organic thickener | <0.5% |
| Mainly aliphatic organic solvents | Complement to 100% |

An example of the method for preparing the decorative composition or the decorative paint according to the invention is summarized in the following table.

| | | |
|---|---|---|
| Nature of the raw | | approximate |
| material used | Comment about use | % by mass |

Add into the fabrication vessel

| | |
|---|---|
| Organic binder with physical | 13% to 20% |
| drying (evaporation of solvents) | |
| and oxidative drying | |
| Mainly aliphatic organic | 9% to 14% |
| solvents | |

Add while stirring

| | |
|---|---|
| Thickening mineral filler | <5% |
| Pearly pigments of the mica- | 5% to 20% |
| titanium dioxide type | |

Stir until a uniform mix is obtained
Add while stirring
Adjust the rotation speed to maintain a good vortex

| | |
|---|---|
| Organic binder with physical | 17% to 25% |
| drying (evaporation of solvents) | |
| and oxidative drying | |
| Pigments or coloring agents | <10% |
| Drying metal soaps | <1% |
| Anti-skinning agent | <1% |
| Organic thickener | <0.5% |
| Mainly aliphatic organic | Make up to 100% |
| solvents | |

Stir until a uniform mix is obtained
Take a sample for quality control

This method uses the “Bénard cells” phenomenon, the principle of which is shown in FIG. 4, to obtain “cells” during drying of the paint coat spread on a horizontal surface.

In this FIG. 4, a coat 1 with composition according to the invention is placed on a substrate 2.

The solvents present in the product evaporate in contact with air at ambient temperature as shown by arrows F in FIG. 4. The latent heat of vaporization (change from liquid state to gas state) of these solvents, cools the liquid in contact with air.

Therefore there is a temperature gradient within the wet paint coat 1. The part in contact with the substrate 2 is warmer while the part in contact with air A is cooler. The result is a difference in density between the lower part and the upper part of the wet film, which causes paint circulation (convection). Solid particles present in the product are preferably concentrated in some stones as a function of the paint circulation and the resulting formation of cells C. The cells appear when liquid convection begins. This phenomenon stops and is fixed when drying is sufficiently advanced.

In other words, for the convection phenomenon to occur (paint circulation), the part in contact with the substrate must be warmer and the part in contact with air most be cooler so as to have a temperature gradient within the wet paint coat, and thus to create a difference in density between the lower part and the upper part of the wet film. This is only possible if the composition with a certain thickness is used, which is why the composition is not intended for use on non-plane, non-horizontal surfaces, or surfaces with concave or convex shapes.

The effects of the honeycomb product obtained can vary as a function of the proportions of each of the ingredients used, and the sequence in which they are used.

The product obtained by use of the method is in the liquid or fluid state with a viscosity of the order of 1000 mPa·s (milli Pascal-seconds). It may be packaged in any appropriate receptacle (flask, jar, tube, etc.). The receptacles containing the product may be provided with a spout in order to dose the product and to control its flow-while pouring it on a substrate. The product may also be applied on a substrate by means of a pipette or any other suitable instrument.

The invention also relates to products for which at least one surface is covered by the decorative paint (bracelets, various boxes, jewelry boxes, table sets, etc.) or articles composed essentially of the decorative paint itself (earrings, coasters, table sets, etc.).

According to another characteristic of the invention, the visible faces of objects to which the decorative paint according to the invention is applied and articles formed by the more or less thick coat of this paint may be covered by a transparent protective layer, for example composed of a glazing resin, after complete drying of said decorative paint.

1. Composition for the decoration of surfaces and for producing decorative objects, characterized in that it comprises a colloidal mix containing an organic binder with physical drying (evaporation of solvents), pearly pigments, coloring pigments, mainly aliphatic organic solvents, and in that the decorative composition is in the form of a homogenized liquid product that can be poured on a horizontal surface so as to form a uniform colored coat that has a random mosaic appearance after a drying time.

2. Composition for the decoration of surfaces and for producing decorative objects according to claim 1, characterized in that the organic physical drying binder is an oxidative drying binder.

3. Composition for the decoration of surfaces and for producing decorative objects according to claim 1, characterized in that the pearly pigments are mica-titanium dioxide type pigments.

4. Composition for the decoration of surfaces and for producing decorative objects according to claim 1, characterized in that the colloidal mix according to the invention contains a thickening mineral filler.

5. Composition for the decoration of surfaces and for producing decorative objects according to claim 1, characterized in that this colloidal mix also contains drying metal soaps.

6. Composition for the decoration of surfaces and for producing decorative objects according to claim characterized in that this mix advantageously contains an organic thickener.

7. Composition for the decoration of surfaces and for producing decorative objects according to claim 1, characterized in that said composition contains an anti-skinning agent.

8. Composition for the decoration of surfaces and for producing decorative objects according to claim 1, characterized by the following approximate percents by mass of raw materials used in the composition of the decorative paint:
Organic binder with physical drying (evaporation of solvents) and oxidative drying: 30% to 45%;
Pearly mica-titanium dioxide pigments: 5% to 20%;
Coloring pigments: <10%;
Thickening mineral filler: <5%:
Drying metal soaps: <1%;
Organic thickener: <0.5%; and
Mainly aliphatic organic solvents: Complement to 100%.

9. Composition for the decoration of surfaces and for producing decorative objects according to claim 1, characterized in that it has a viscosity of the order of 1000 mPa·s (milli Pascal-seconds).

10. Method for preparing the decorative composition according to claim 1, characterized in that a first quantity of organic binder of the order of 13% to 20%, with physical and oxidative drying and a first, quantity of mainly aliphatic organic solvents of the order of 9% to 14%, are added into a vessel, these ingredients being stirred by a mixer installed in said vessel; a thickening mineral filler and pearly pigments of mica-titanium dioxide are then added, while stirring, stirring is continued until a homogeneous mix is obtained; an additional quantity of organic binder with physical and oxidative drying of the order of 17 to 25%, coloring pigments, one or several of the following other ingredients—drying metal soaps, anti-skinning agent, organic thickener, and a complementary quantity of mainly aliphatic organic solvents (percent to makeup the mass to 100%) are added while stirring.

11. Decorative articles characterized in that they are coated with a decorative paint according to claim 1, such as jewelry, bracelets, miscellaneous boxes, jewelry boxes, earrings, table sets, or composed of a solidified layer of this decorative paint such as table sets and coasters.

12. Decorative articles according to claim 11, characterized in that the decorative and visible face(s) of objects to which the decorative paint is applied is (are) covered with a transparent protective coat, for example composed of a glazing resin.
